(19) United States
(12) Patent Application Publication
(10) Pub. No.: US 2025/0321599 A1
(43) Pub. Date: Oct. 16, 2025

(54) UNMANNED AERIAL VEHICLE AND STOP SYSTEM

(71) Applicant: Kubota Corporation, Osaka (JP)

(72) Inventor: Kohei SEINO, Sakai-shi (JP)

(21) Appl. No.: 19/248,016

(22) Filed: Jun. 24, 2025

Related U.S. Application Data
(63) Continuation of application No. PCT/JP2022/048192, filed on Dec. 27, 2022.

(51) Int. Cl. G05D 1/86; G05D 1/85; G05D 109/25

(52) U.S. Cl. CPC G05D 1/86; G05D 1/854; G05D 2109/254

(57) ABSTRACT

An unmanned aerial vehicle includes a plurality of electric motors each configured to rotate a respective one of a plurality of rotors, a plurality of motor drive circuits each configured to drive a respective one of the plurality of electric motors, and a controller configured or programmed to control operation of the plurality of motor drive circuits. The controller is configured or programmed to change the operation of the plurality of motor drive circuits from a flight state of the unmanned aerial vehicle to a state where flight is not possible in response to a stop signal.

### CROSS REFERENCE TO RELATED APPLICATIONS

This application is a Continuation Application of PCT Application No. PCT/JP2022/048192 filed on Dec. 27, 2022. The entire contents of this application are hereby incorporated herein by reference.

### BACKGROUND OF THE INVENTION

### 1. Field of the Invention

The present disclosure relates to unmanned aerial vehicles and termination systems.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Japanese Patent Application Publication No. 2020-134157 describes a fault diagnosis circuit for diagnosing open-sticking or closed-sticking of relays used in PLCs (Programmable Logic Controllers).

### SUMMARY OF THE INVENTION

Unmanned aerial vehicles may include relay circuits for emergency stopping of rotor rotation. Technical improvements for fault diagnosis of the relay circuits are desired.

Example embodiments of the present disclosure provide termination systems each capable of terminating the flight of an unmanned aerial vehicle, and unmanned aerial vehicles including such termination systems.

In a non-limiting example embodiment of the present disclosure, an unmanned aerial vehicle includes a plurality of rotors, a plurality of electric motors each configured to rotate a respective one of the plurality of rotors, a plurality of motor drive circuits each configured to drive a respective one of the plurality of electric motors, and a controller configured or programmed to control operation of the plurality of motor drive circuits, wherein the controller is configured or programmed to change the operation of the plurality of motor drive circuits from a flight state of the unmanned aerial vehicle to a state where flight is not possible in response to a stop signal.

In a non-limiting example embodiment of the present disclosure, a termination system, which is usable in an unmanned aerial vehicle including a plurality of rotors, a plurality of electric motors each configured to rotate a respective one of the plurality of rotors, a plurality of motor drive circuits each configured to drive a respective one of the plurality of electric motors, and a controller configured or programmed to control operation of each of the plurality of motor drive circuits, is configured or programmed to output a stop signal to the controller to change the operation of the plurality of motor drive circuits from a flight state of the unmanned aerial vehicle to a state where flight is not possible.

According to example embodiments of the present disclosure, termination systems each capable of terminating the flight of an unmanned aerial vehicle, and unmanned aerial vehicles including such termination systems, are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid type multicopter.

FIG. 2C is a block diagram showing a basic configuration example of a parallel hybrid type multicopter.

FIG. 3 is a block diagram showing a detailed configuration example of a relay circuit and a diagnostic device.

FIG. 4 is a flowchart showing example 1 of a fault diagnosis procedure performed by the diagnostic device.

FIG. 5 is a flowchart showing example 2 of a fault diagnosis procedure performed by the diagnostic device.

FIG. 6 is a flowchart showing example 3 of a fault diagnosis procedure performed by the diagnostic device.

FIG. 7 is a schematic diagram showing an example in which a multicopter, an agricultural machine, a server, and a terminal device are connected via a communication network.

### DETAILED DESCRIPTION OF THE EXAMPLE EMBODIMENTS

Unmanned aerial vehicles each include a plurality of rotors and a rotation driver to rotate the rotors (hereinafter referred to as “propellers”). Hereinafter, such an unmanned aerial vehicle is referred to as a “multicopter”.

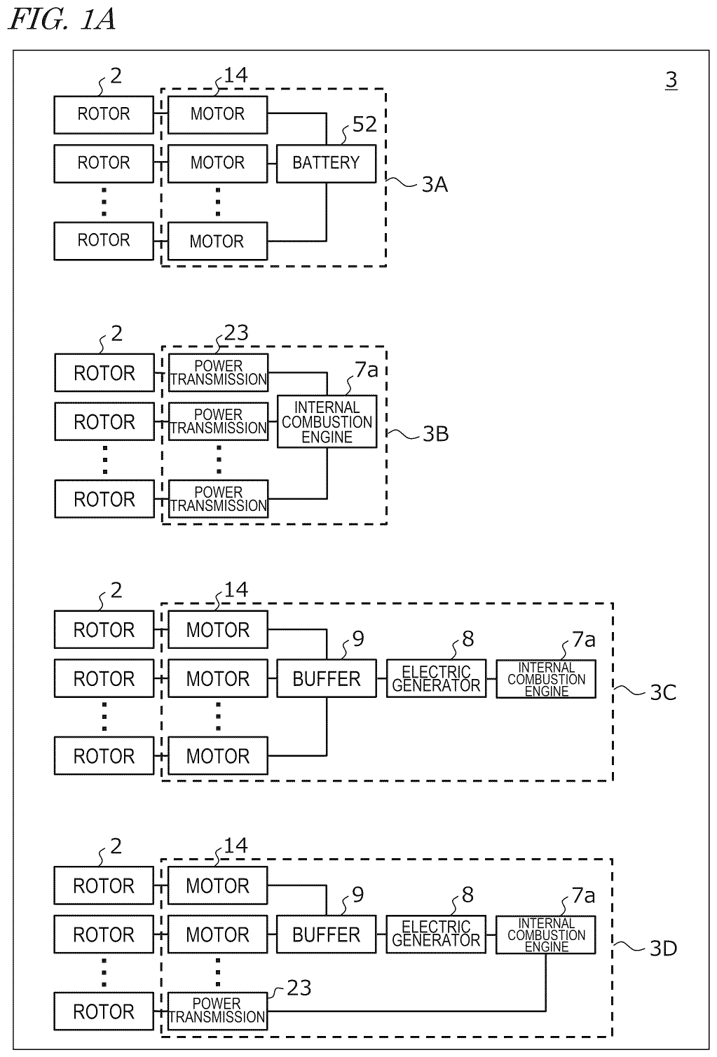

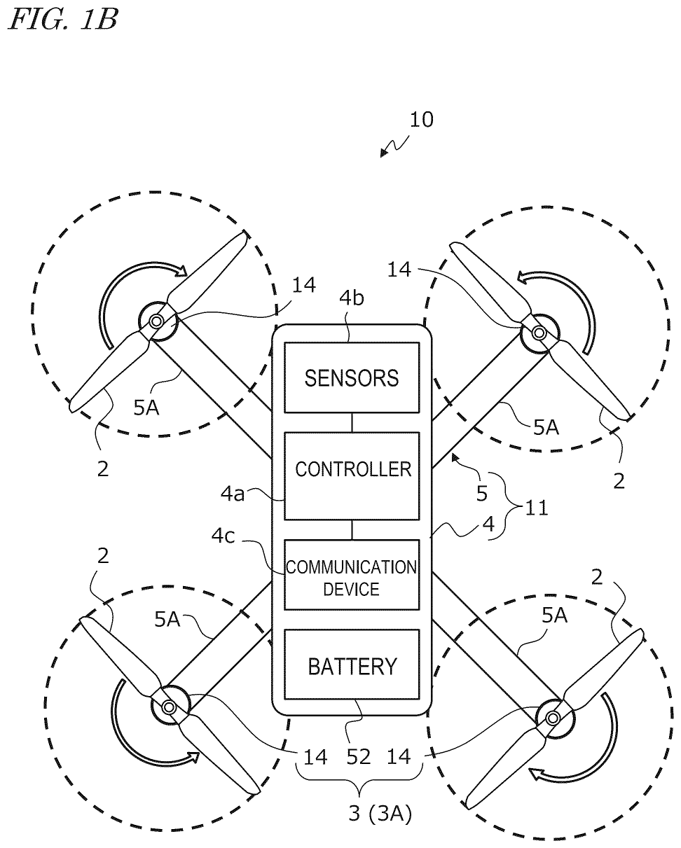

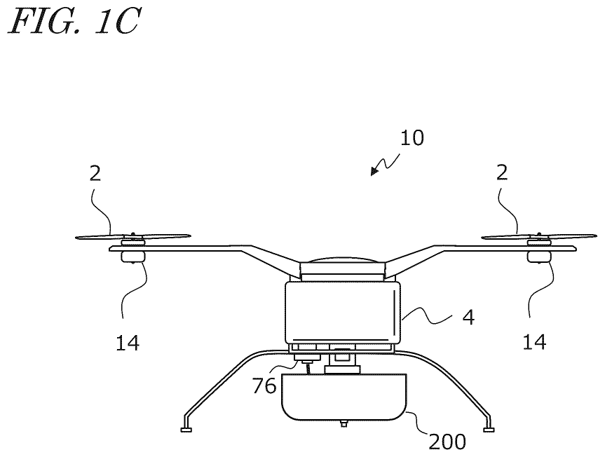

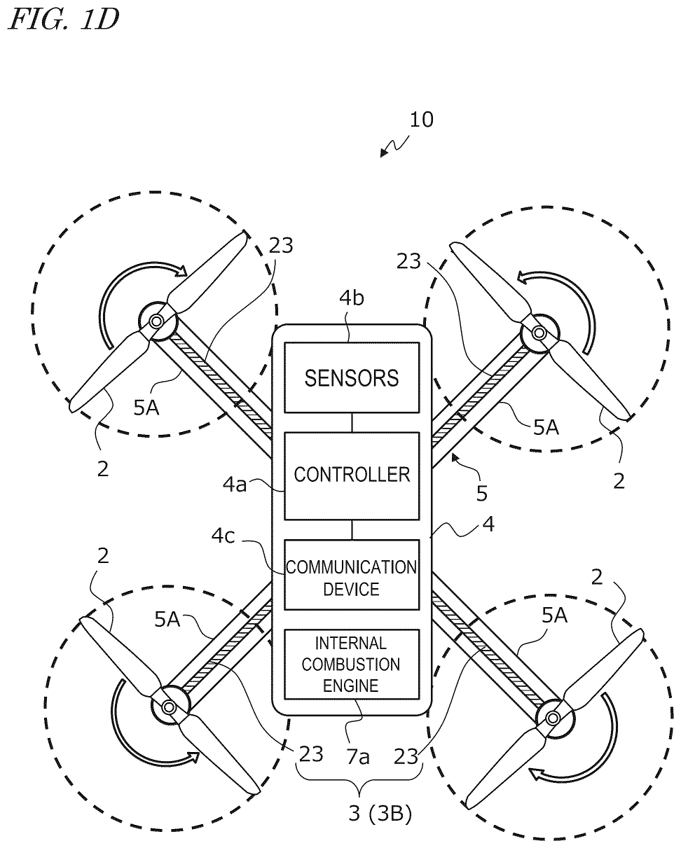

The configuration of rotation drivers included in multicopters exists in various forms. FIG. 1A is a schematic block diagram showing four examples of a rotation driver 3 according to example embodiments of the present disclosure.

The first rotation driver 3A shown in FIG. 1A includes a plurality of electric motors (hereinafter referred to as “motors”) 14 that rotate a plurality of rotors, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of the battery 52. While the power storage capacity of the battery 52 can be increased by making the battery 52 larger, enlarging the battery 52 leads to an increase in weight.

The second rotation driver 3B shown in FIG. 1A includes a power transmission system 23 mechanically connected to the rotor 2, and an internal combustion engine 7a that provides driving force (torque) to power transmission system 23. The power transmission system 23 includes mechanical components such as gears or belts and transmits torque from the output shaft of internal the combustion engine 7a to the rotor 2. The internal combustion engine 7a can efficiently generate mechanical energy through fuel combustion. Examples of the internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of the power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of the internal combustion engine 7a. This type of driver is called “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, and a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by motors 14. In the fourth rotation driver 3D, since mechanical energy generated by the internal combustion engine 7a can be utilized for rotor rotation without conversion to electrical energy, energy utilization efficiency can be enhanced. This type of driver is called “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes the motors 14 and a battery 52. FIG. 1C is a side view schematically showing the multicopter.

The multicopter 10 shown in FIGS. 1B and 1C includes a plurality of rotors 2, a main body 4, and a body frame 5 that supports the rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A.

In the example of FIG. 1B, the multicopter 10 is a quad-type multicopter (quadcopter) including four rotors 2, for example. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, an angular velocity sensor, a geomagnetic sensor, an atmospheric pressure sensor, an altitude sensor, temperature sensor, a flow sensor, an imaging device, a laser sensor, ultrasonic sensor, an obstacle contact sensor, and a GNSS (Global Navigation Satellite System) receiver. The acceleration sensor and angular velocity sensor may be mounted on the main body 4 as components of an IMU (Inertial Measurement Unit). Examples of laser sensors may include a laser range finder used for measuring distance to the ground, and 2D or 3D LiDAR.

The communication device 4c may include a wireless communication module for signal transmission and reception with a ground-based transmitter or ground control station (GCS) via an antenna, and a mobile communication module that utilizes cellular communication networks. The communication device 4c is configured to receive signals such as control commands transmitted from the ground and transmit sensor data such as image data acquired by sensors 4b as telemetry information. The communication device 4c may also perform functions for communication between multicopters and satellite communication capabilities. The controller 4a may connect to computers in the cloud through the communication device 4c. The computer in the cloud may execute some or all of the functions of the companion computer.

A battery 52 is a secondary battery that is configured to store electric power through charging and supply electric power to motors 14 through discharging. Through the operation of the battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are included, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned more inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by the internal combustion engine 7a is transmitted to the plurality of rotors 2 through a plurality of power transmission systems 23 to rotate each rotor 2. The controller 4a may change the rotational speed of individual rotors 2 by controlling each power transmission system 23.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid driver, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used for generating thrust, and the sub-rotors are used for both generating thrust and attitude control. The main rotors may be called “booster rotors” and the sub-rotors may be called “attitude control rotors”.

In the parallel hybrid driver, the internal combustion engine 7a is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine 7a and uses the internal combustion engine 7a for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt a parallel hybrid driver or a series hybrid driver to increase payload and flight duration.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. When the implement 200 includes space large enough to store materials, the implement 200 can also transport agricultural materials or harvested crops over a wide area.

In the example shown in FIG. 1C, the multicopter 10 includes the power supply 76. The power supply 76 supplies power to the implement 200 from driving energy sources such as a battery 52 or an electric generator 8 included in the multicopter 10. Various functions of implement 200 may be performed using this power. The implement 200 includes actuators such as motors that operate using power obtained from the power supply 76 of the multicopter 10. The implement 200 preferably includes a battery for storing power.

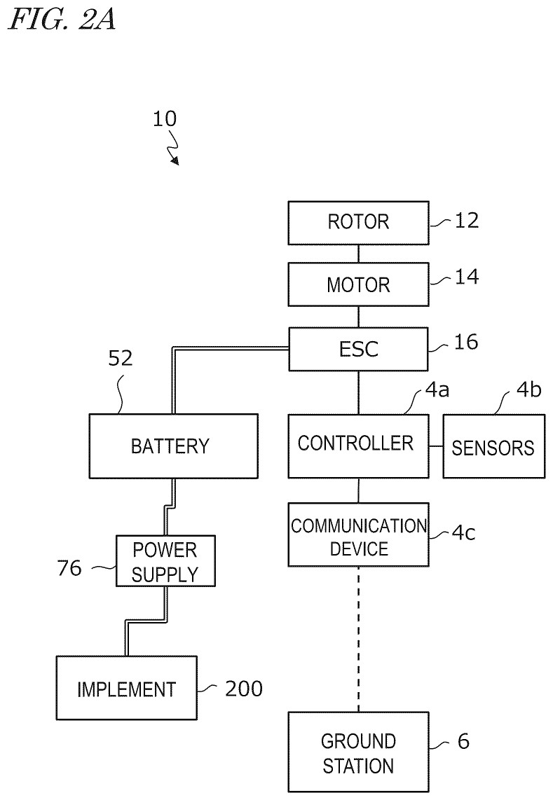

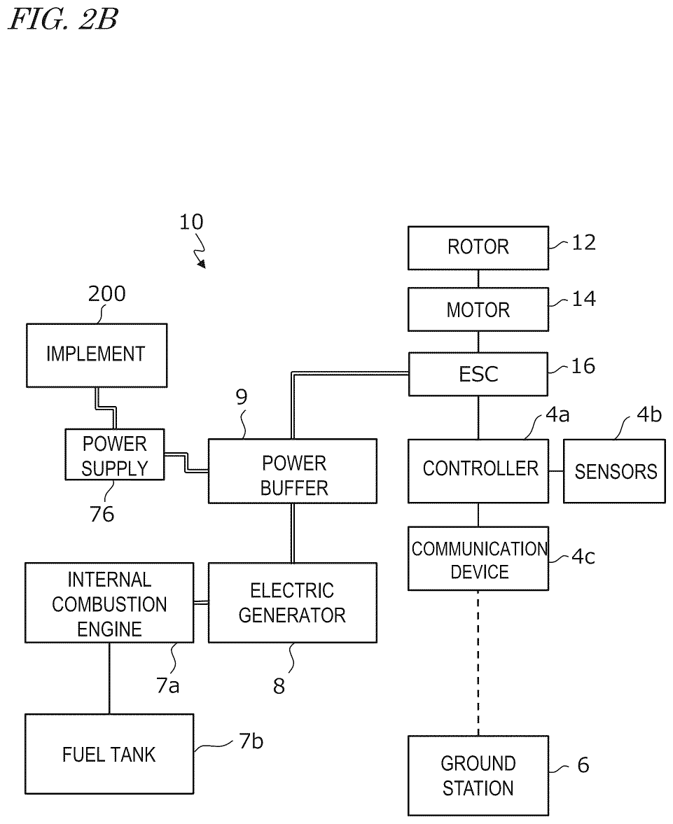

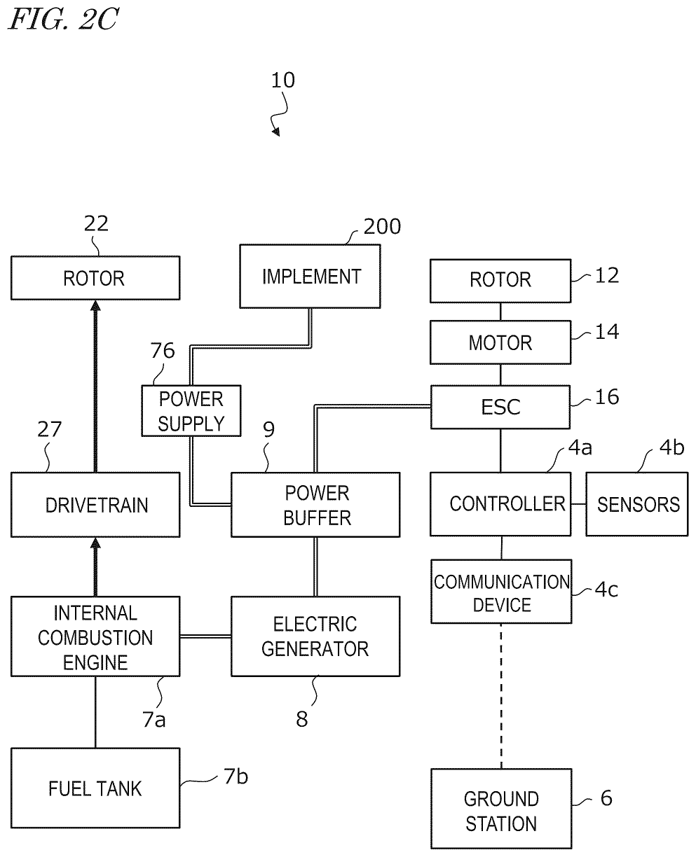

FIG. 2A is a block diagram showing a basic configuration example of a battery-driven multicopter 10. The battery-driven multicopter 10 includes a plurality of rotors 12, a plurality of motors 14 each rotating a respective one of the plurality of rotors 12, a plurality of ESCs (Electric Speed Controllers) 16 each having a motor drive circuit that drives a respective one of the plurality of motors 14, a battery 52 that supplies power to each motor 14 through respective ESC 16, a controller 4a configured or programmed to control the plurality of ESCs 16 to control attitude while flying, sensors 4b, a communication device 4c, and a power supply 76 that is electrically connected to the battery 52. Rotor 12 is an example of rotor 2. The devices such as controller 4a, sensors 4b, and communication device 4c are communicably connected to each other via, for example, a CAN (Controller Area Network) bus. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C.

The controller 4a may receive control commands wirelessly from, for example, a ground station 6 on the ground through the communication device 4c. The number of ground stations 6 is not limited to one, and the ground station 6 may be distributed across a plurality of locations. The communication device 4c may also wirelessly receive control commands from an operator's control terminal on the ground. The controller 4a may be configured or programmed to perform functions to automatically or autonomously execute takeoff, flight, obstacle avoidance, and landing operations based on sensor data obtained from the sensors 4b.

The controller 4a may be configured or programmed to communicate with the implement 200 connected to the power supply 76 and obtain signals indicating the state of the implement 200 from the implement 200. Additionally, the controller 4a may provide signals to control the operation of implement 200. Furthermore, the implement 200 may generate signals to instruct the operation of multicopter 10 and transmit them to the controller 4a. Such communication between the controller 4a and the implement 200 may be conducted through wired or wireless means.

The multicopter 10 according to an example of the present disclosure further includes a relay circuit 80 configured to interrupt control signals transmitted from the controller 4a to each ESC 16 in response to a stop signal to stop the rotation of the plurality of rotors 12, and a diagnostic device 82 that executes fault diagnosis of the relay circuit 80 based on the output from the relay circuit 80. In this description, the relay circuit 80 and the diagnostic device 82 are collectively referred to as a “termination system”. The termination system may be utilized to emergency stop the rotation of the plurality of rotors 12. Therefore, the termination system may also be referred to as a “safety device”.

The relay circuit 80 is electrically connected between the plurality of ESCs 16 (or the plurality of motor drive circuits) and the controller 4a. The relay circuit 80 includes a plurality of relays corresponding to the plurality of ESCs 16. The detailed configuration and operation of the termination system including the relay circuit 80 and the diagnostic device 82 will be described in detail later.

FIG. 2B is a block diagram showing a basic configuration example of a series hybrid drive type multicopter 10. The series hybrid drive type multicopter 10 includes, similar to the battery-driven multicopter 10, a plurality of rotors 12, a plurality of motors 14, a plurality of ESCs 16, a controller 4a, sensors 4b, a communication device 4c, a relay circuit 80, and a diagnostic device 82. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to motors 14 through the power buffer 9 and ESCs 16. Additionally, the electric power generated by the electric generator 8 may be supplied to the implement 200 through the power supply 76.

FIG. 2C is a block diagram showing a basic configuration example of a parallel hybrid drive type multicopter 10. The parallel hybrid drive type multicopter 10 includes, similar to the series hybrid drive type multicopter 10, a plurality of rotors 12, a plurality of motors 14, a plurality of ESCs 16, a controller 4a, sensors 4b, a communication device 4c, a relay circuit 80, a diagnostic device 82, an internal combustion engine 7a, a fuel tank 7b, an electric generator 8, a power buffer 9, and a power supply 76. The parallel hybrid drive type multicopter 10 further includes a drivetrain 27 that transmits driving force from the internal combustion engine 7a, and a rotor 22 that rotates upon the receiving driving force from the internal combustion engine 7a through the drivetrain 27. The rotor 22 is an example of rotor 2. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

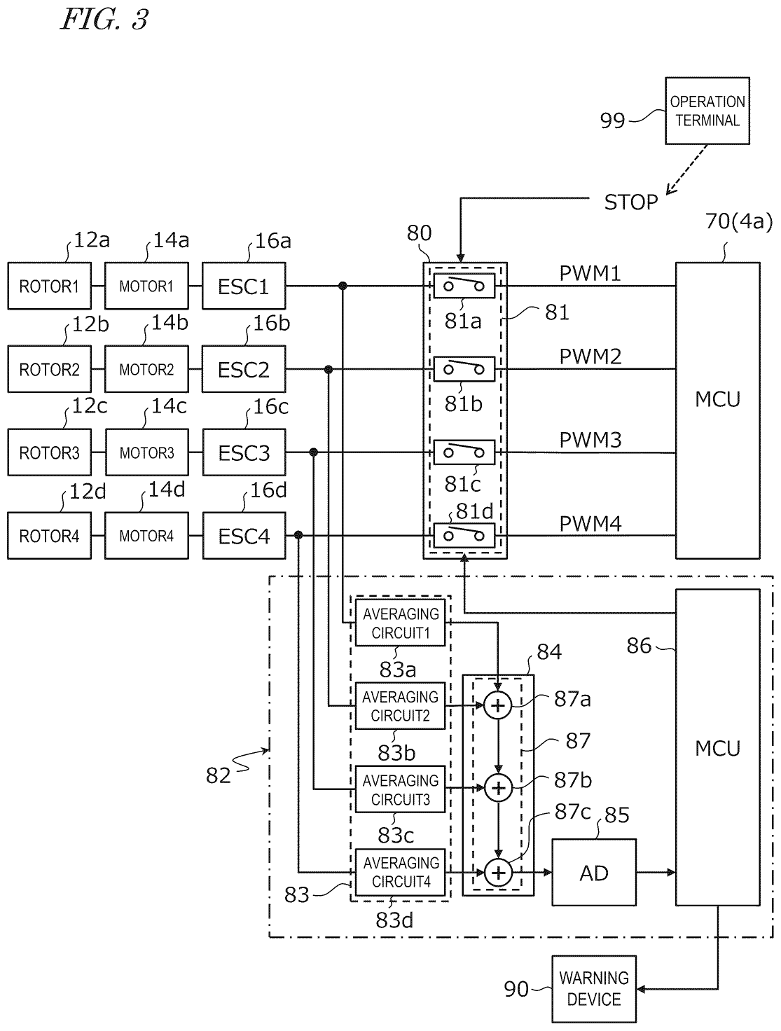

FIG. 3 is a block diagram showing a detailed configuration example of the relay circuit 80 and the diagnostic device 82. FIG. 3 shows a configuration example of a relay circuit 80 and a diagnostic device 82 (that is, a termination system) mounted on a quad-type multicopter. However, the multicopter is not limited to a quad-type multicopter and may be, for example, a hexa-type multicopter (hexacopter) with six rotors, or an octo-type multicopter (octocopter) with eight rotors.

In the example shown in FIG. 3, the quad-type multicopter includes four rotors 12a-12d, four motors 14a-14d that respectively rotate the four rotors 12a-12d, four ESCs 16a-16d that respectively drive the four motors 14a-14d, a controller (Micro Controller Unit: MCU) 70, a relay circuit 80 electrically connected between the four ESCs 16a-16d and the controller 70, and a diagnostic device 82 connected between the relay circuit 80 and the four ESCs 16a-16d, for example. The rotor 12a, motor 14a, and ESC 16a may be collectively referred to as “first system”, the rotor 12b, motor 14b, and ESC 16b as “second system”, the rotor 12c, motor 14c, and ESC 16c as “third system”, and the rotor 12d, motor 14d, and ESC 16d as “fourth system”.

The controller 70 is configured or programmed to control the operation of each of the plurality of motor drive circuits (ESCs 16) and transmit control signals to control the rotation speed of the rotors 12 to each of the plurality of motor drive circuits. In other words, the controller 70 is configured or programmed to transmit control commands to control the rotation speed of each rotor 12 to the first to fourth systems respectively. Rotation speed is also called revolution number. The revolution number is the number of revolutions per unit time, expressed, for example, in revolutions per minute (rpm). In the example shown in FIG. 3, the controller 70 controls the operation of each of the four ESCs 16a-16d and transmits control signals to control the rotation speed of each rotor 12 to each of the four ESCs 16a-16d. An example of the controller 70 is the aforementioned flight controller. In the following description, to distinguish from the second controller to be described later, the controller 70 is referred to as “first controller 70”.

In an example embodiment of the present disclosure, an example of a control signal to control the rotation speed of each rotor 12 is a PWM (Pulse Width Modulation) signal, which is a pulse signal. The first controller 70 outputs a PWM signal having a duty ratio that defines the command value of the rotation speed of each motor 14. The duty ratio has a magnitude proportional to the rotation speed (command value). The duty ratio during fault diagnosis described later is set, for example, in the range of 40% to 80%.

The controller 70 is further configured or programmed to change the operation of the plurality of motor drive circuits from a flight state of the multicopter to a state where flight is not possible in response to a stop signal (shown as STOP in FIG. 3). The stop signal is a signal transmitted to stop the rotation of the plurality of rotors 12. In other words, the stop signal is a signal transmitted to stop the operation of the plurality of motor drive circuits.

The relay circuit 80 is configured to interrupt control signals transmitted from the first controller 70 to each ESC 16 in response to the stop signal. The relay circuit 80 includes a plurality of relays 81 each of which is configured to interrupt the control signal in response to the stop signal.

The termination system in this example embodiment is configured or programmed to output a stop signal to the controller 70 and change the operation of the plurality of motor drive circuits from a flight state of the multicopter to a state where flight is not possible. The termination system may include an operation terminal 99 to output a stop signal to the controller 70. The operation terminal 99 is capable of notifying the multicopter of a flight stop command, for example, when the multicopter is positioned above a field. This sends a stop signal to the controller 70. Examples of operation terminal 99 include terminal devices, mobile terminals such as smartphones or tablet computers. The stop signal is transmitted, for example, from the aforementioned companion computer in response to a flight stop command transmitted from the operation terminal 99 used by an operator. Alternatively, the companion computer may determine whether there is an emergency situation based on, for example, sensor data obtained from the sensors 4b, and transmit a stop signal to the relay circuit 80 according to the determination result. The operator can intentionally stop the rotation of the multiple rotors of the multicopter by transmitting a flight stop command from the operation terminal 99 to the multicopter. For example, when flying over a place with few buildings such as a field (agricultural work site), in case of an emergency where flight cannot be continued or flight is unstable, an emergency response such as forced landing or forced crash of the multicopter can be performed.

In the example shown in FIG. 3, the relay circuit 80 is configured to interrupt PWM signals transmitted from the first controller 70 to each ESC 16 in response to a stop signal to stop the rotation of the four rotors 12a-12d. Specifically, the relay circuit 80 has four relays 81a-81d each of which is configured to interrupt the PWM signal in response to the stop signal. The relay circuit 80 may further include transistors for turning on and off each relay. One end of the relay 81a is connected to the ESC 16a, and the other end of the relay 81a is connected to the first controller 70. One end of the relay 81b is connected to the ESC 16b, and the other end of the relay 81b is connected to the first controller 70. One end of the relay 81c is connected to the ESC 16c, and the other end of the relay 81c is connected to the first controller 70. One end of the relay 81d is connected to the ESC 16d, and the other end of the relay 81d is connected to the first controller 70.

PWM signals PWM1-PWM4 transmitted from the first controller 70 are input to the first to fourth systems through the four relays 81a-81d respectively. During operations such as takeoff, flight, or landing, all four relays 81a-81d are constantly in the ON state. In an emergency, all four relays 81a-81d change to the OFF state in response to the stop signal.

Each of the plurality of relays in the relay circuit 80 may potentially experience an ON failure or an OFF failure. An ON failure is a failure where the relay is always in the ON state and does not transition to the OFF state, and an OFF failure is a failure where the relay is always in the OFF state and does not transition to the ON state. An ON failure may be referred to as “ON-sticking” and an OFF failure as “OFF-sticking”.

To make the relay circuit 80 function as a safety device, it is important to verify the operation of the relay circuit 80 before the multicopter flies. The diagnostic device 82 is configured or programmed to perform diagnosis of ON/OFF failures of the plurality of relays. The diagnostic device 82 preferably is configured or programmed to execute fault diagnosis of the relay circuit 80 before the multicopter takes off. In other words, the diagnostic device 82 preferably performs diagnosis of ON/OFF failures of the plurality of relays before the multicopter takes off. However, the timing of ON/OFF failure diagnosis is not limited to before takeoff and may be, for example, after landing.

The multicopter according to an example embodiment of the present disclosure may include a warning device 90 as shown in FIG. 3. The warning device 90 issues a warning about an ON/OFF failure of at least one of the plurality of relays. Examples of the warning device 90 include a buzzer that emits a warning sound to report a relay failure, or an optical device such as an LED (Light Emitting Diode) lamp. For example, the diagnostic device 82 may perform diagnosis of ON/OFF failures of the plurality of relays when the multicopter is powered on. The diagnostic device 82 causes the warning device 90 to issue a warning when it detects an ON/OFF failure of at least one of the plurality of relays. This makes it possible to verify the operation of the relay circuit 80 before the multicopter flies, ensuring the safety of the multicopter. When a failure of the relay circuit 80 is detected, it is possible to prompt the operator to cancel the flight of the multicopter, for example, by a warning sound emitted by the buzzer.

The diagnostic device 82 includes a plurality of averaging circuits 83, an integration circuit 84, an analog-to-digital (AD) converter circuit 85, and a second controller (MCU) 86. However, if the second controller 86 is configured or programmed to perform an AD conversion function, the AD converter circuit 85 is not necessary. The plurality of averaging circuits 83 are connected to the ESC 16 side of the plurality of relays respectively. Each of the plurality of averaging circuits 83 outputs an analog voltage corresponding to the duty ratio of the PWM signal. The integration circuit 84 includes one or more adders 87 and outputs a summed value by summing the output values from each of the plurality of averaging circuits 83. The AD converter circuit 85 converts the summed value output from the integration circuit 84 as an analog signal into a digital signal. The second controller 86 detects an ON/OFF failure of at least one of the plurality of relays 81 based on the summed value output from the integration circuit 84. More specifically, the second controller 86 detects an ON/OFF failure of at least one of the plurality of relays based on the output value of the digital signal output from the AD converter circuit 85.

In the example shown in FIG. 3, four averaging circuits 83a-83d are connected to the ESC 16 side of four relays 81a-81d, respectively, for example. Specifically, the averaging circuit 83a is connected to one end of the relay 81a and to the integration circuit 84. The averaging circuit 83b is connected to one end of the relay 81b and to the integration circuit 84. The averaging circuit 83c is connected to one end of the relay 81c and to the integration circuit 84. The averaging circuit 83d is connected to one end of the relay 81d and to the integration circuit 84. With such electrical connections, PWM signals output from the first controller 70 are input to each ESC 16 and each averaging circuit 83 through each relay 81.

Each averaging circuit 83 converts the input PWM signal into an analog voltage signal corresponding to its duty ratio. For example, with a duty ratio of 40% each averaging circuit 83 converts the input PWM signal to an analog voltage signal of 0.25V. With a duty ratio of 80% each averaging circuit 83 converts the input PWM signal to an analog voltage signal of 0.5V, for example.

The integration circuit 84 includes an adder 87a that adds the output from the averaging circuit 83a and the output from the averaging circuit 83b, an adder 87b that adds the output from the averaging circuit 83c and the output from the adder 87a, and an adder 87c that adds the output from the averaging circuit 83d and the output from the adder 87b. For example, with a duty ratio of 40%, when all four relays 81a-81d are in the ON state, the summed value output from the integration circuit 84 is 1V. With a duty ratio of 80%, when all four relays 81a-81d are in the ON state, the summed value output from the integration circuit 84 is 2V, for example. Thus, in the four systems, with a duty ratio of 40-80%, the summed value output from the integration circuit 84 is, for example, 1-2V. In other words, a digital signal corresponding to an analog signal of 1-2V is input to the second controller 86. In the case of eight systems, the summed value output from the integration circuit 84 would be, for example, 2-4V.

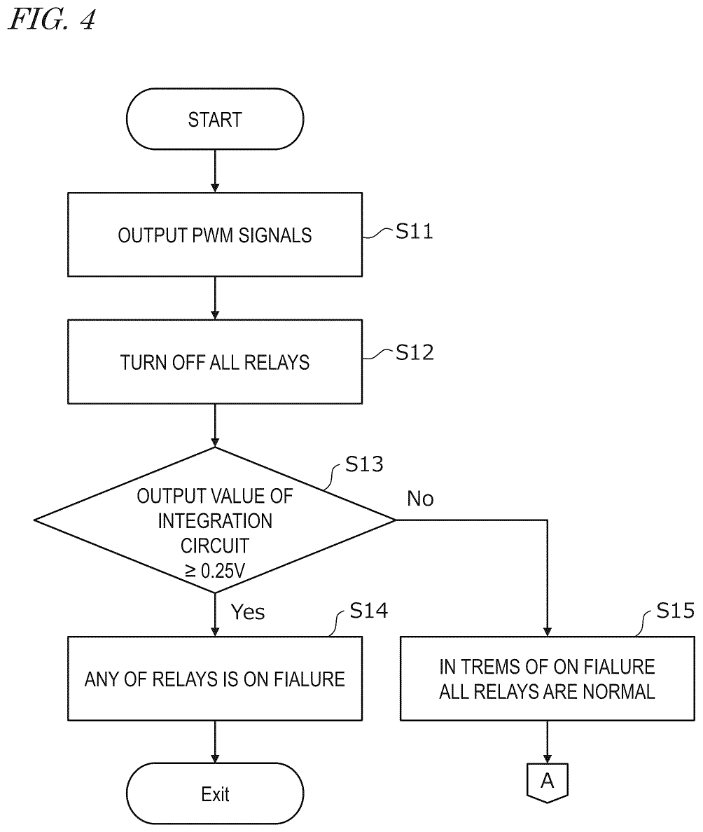

FIG. 4 is a flowchart showing example 1 of a fault diagnosis procedure performed by the diagnostic device 82. Example 1 shows a procedure for diagnosing whether any of the plurality of relays has an ON failure. In an example embodiment of the present disclosure, the diagnostic device 82 performs fault diagnosis when the multicopter is powered on. With reference to FIG. 4, the method for diagnosing an ON failure of a relay will be explained in detail.

First, the first controller 70 outputs a PWM signal to each of the first to fourth systems (step S11). In example 1, the duty ratio of the PWM signal is 40%. However, the duty ratio is not limited to this value.

Next, the second controller 86 of the diagnostic device 82 outputs a control signal for relay opening and closing to the relay circuit 80, thereby turning OFF all four relays 81a-81d (step S12). The second controller 86 controls the ON/OFF operation of each of the four relays 81a-81d. For example, the second controller 86 controls the four relays 81a-81d so that all four relays 81a-81d are in the OFF state when the PWM signal is input from the first controller 70 to the relay circuit 80. However, the order of the processes in steps S11 and S12 may be reversed. That is, the PWM signal may be input from the first controller 70 to the relay circuit 80 after all four relays 81a-81d are turned OFF.

The second controller 86 determines (or diagnoses) whether at least one of the four relays 81a-81d has an ON failure by comparing the summed value output from the integration circuit 84 with a first threshold (step S13). Here, the first threshold is determined based on the duty ratio of the PWM signal. In example 1, the duty ratio is 40%, and in this case, an analog voltage signal of 0.25V is output from the averaging circuit connected to a relay in the ON state. If at least one of the four relays 81a-81d is in the ON state, a summed value of 0.25V or more is output from the integration circuit 84. Therefore, 0.25V is set as the first threshold.

If all four relays 81a-81d are in the OFF state, the output value of the output signal from the integration circuit 84 (or AD converter circuit 85) is zero. In contrast, if at least one of the four relays 81a-81d has an ON failure, an output signal with an output value proportional to the number of relays with an ON failure is output from the integration circuit 84. In example 1, for instance, if one of the four relays 81a-81d has an ON failure, the summed value output from the integration circuit 84 is 0.25V, and if two of the four relays 81a-81d have an ON failure, the summed value output from the integration circuit 84 is 0.5V.

If the second controller 86 determines that the summed value output from the integration circuit 84 is equal to or greater than the first threshold (Yes in step S13), it determines that at least one of the four relays 81a-81d has an ON failure (step S14). In contrast, if the second controller 86 determines that the summed value output from the integration circuit 84 is less than the first threshold (No in step S13), it determines that all four relays 81a-81d are normal in terms of ON failure (step S15).

When the second controller 86 detects an ON failure of at least one of the four relays 81a-81d in step S14, it may send a warning command to the warning device 90. The warning device 90 emits a warning sound, for example, in response to the warning command. When the second controller 86 determines in step S15 that all relays are normal in terms of ON failure, it proceeds to the process for diagnosing OFF failure.

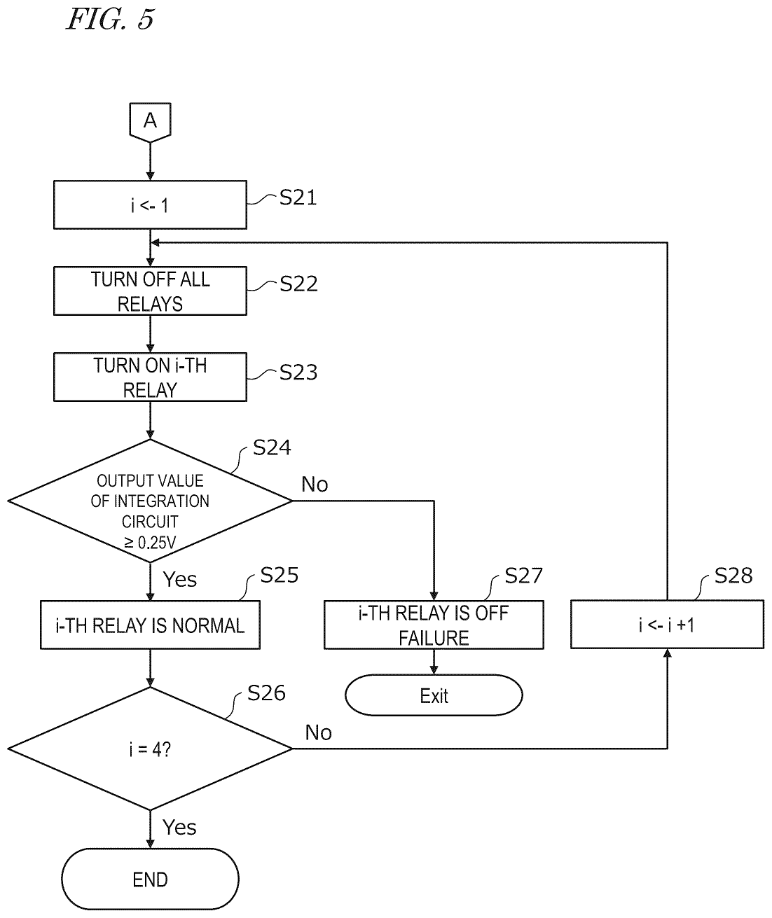

FIG. 5 is a flowchart showing example 2 of a fault diagnosis procedure performed by the diagnostic device 82. Example 2 shows a procedure for identifying a relay with an OFF failure among the plurality of relays. The duty ratio of the PWM signal in example 2 is 40%, similar to example 1. The diagnostic device 82 sequentially executes OFF failure diagnosis for the relay 81a, relay 81b, relay 81c, and relay 81d in this order.

First, the first controller 70 selects the relay 81a, which is first in the diagnostic order, as the target for OFF failure diagnosis (step S21). Next, the second controller 86 outputs a control signal to the relay circuit 80 to turn OFF all four relays 81a-81d to turn OFF all four relays 81a-81d (step S22). Then, the second controller 86 controls the relay circuit 80 to turn ON relay 81a while keeping the three relays 81b-81d in the OFF state (step S23). In other words, the second controller 86 controls the four relays 81a-81d so that after all four relays 81a-81d are turned OFF when the PWM signal is input from the first controller 70 to the relay circuit 80, only relay 81a among the four relays 81a-81d turns ON.

The second controller 86 identifies a relay with an OFF failure among the four relays 81a-81d by comparing the summed value output from the integration circuit 84 with a second threshold. Here, the second threshold is determined based on the duty ratio of the PWM signal, similar to the first threshold. In example 2, the duty ratio is 40%, and in this case, an analog voltage signal of 0.25V is output from the averaging circuit connected to a relay in the ON state. Therefore, 0.25V is set as the second threshold. If all four relays 81a-81d are normal in terms of OFF failure, when the relay selected as the diagnosis target among the four relays 81a-81d is in the ON state, the summed value output from the integration circuit 84 (or AD converter circuit 85) is 0.25V. In contrast, if the relay selected as the diagnosis target among the four relays 81a-81d has an OFF failure, since the relay will not turn ON, the summed value output from the integration circuit 84 is 0V.

If the second controller 86 determines that the summed value output from the integration circuit 84 is equal to or greater than the second threshold (Yes in step S24), it determines that the relay selected as the diagnosis target among the four relays 81a-81d is normal in terms of OFF failure (step S25). In contrast, if the second controller 86 determines that the summed value output from the integration circuit 84 is less than the second threshold (No in step S24), it determines that the relay selected as the diagnosis target among the four relays 81a-81d has an OFF failure (step S27).

When the second controller 86 detects an OFF failure of one of the four relays 81a-81d in step S27, it may send a warning command to the warning device 90. The warning device 90 emits a warning sound, for example, in response to the warning command.

In this way, the second controller 86 completes the OFF failure diagnosis for the relay 81a, which is first in the diagnostic order. Next, the second controller 86 performs OFF failure diagnosis for the relay 81b, which is second in the diagnostic order, following the same procedure as for the OFF failure diagnosis of the relay 81a (step S28). Subsequently, the second controller 86 repeatedly executes the processes from step S22 to S24 to perform OFF failure diagnosis for the relay 81c, which is third in the diagnostic order, and the relay 81d, which is fourth in the diagnostic order, thereby completing the diagnosis of all relays (step S26).

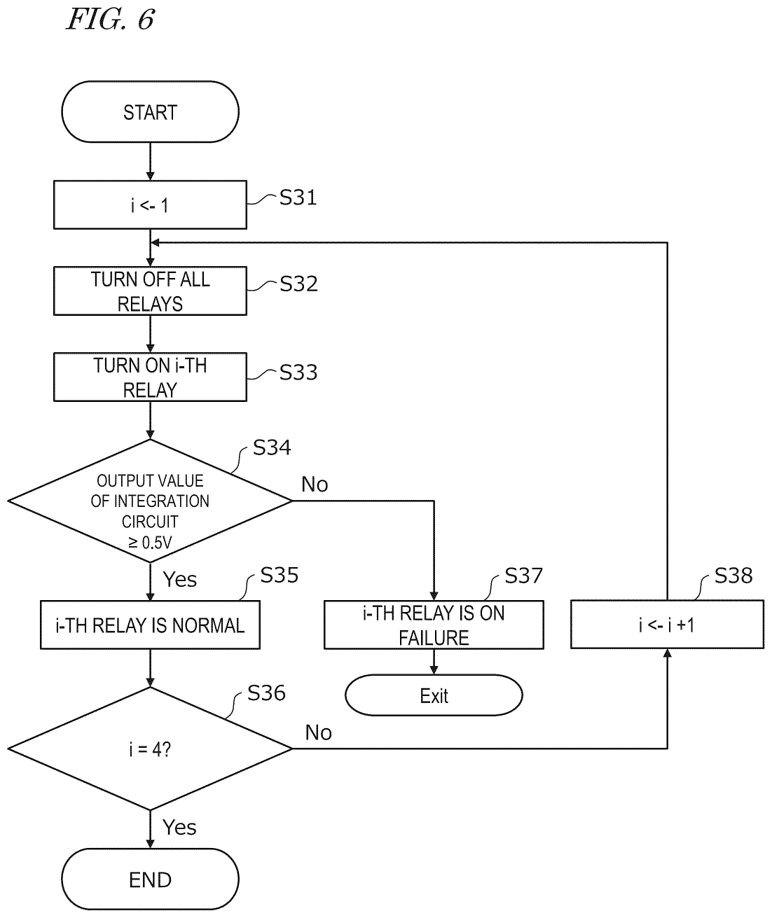

FIG. 6 is a flowchart showing example 3 of a fault diagnosis procedure performed by the diagnostic device 82. Example 3 shows a procedure for identifying a relay with an ON failure among the plurality of relays. The difference between the procedure shown in example 3 and the procedure shown in example 2 is the difference in thresholds. The following mainly explains the points that differ from the procedure in example 2.

When the diagnostic device 82 has determined that any of the four relays 81a-81d has an ON failure as a result of fault diagnosis according to the procedure of example 1, it is possible to identify which relay among the four relays 81a-81d has an ON failure by performing further fault diagnosis according to the procedure of example 3.

A third threshold used to determine an ON failure of one of the four relays 81a-81d is larger than the second threshold used to determine an OFF failure of one of the four relays 81a-81d. The third threshold is determined based on the duty ratio of the PWM signal, similar to the first and second thresholds. In example 3, the duty ratio of the PWM signal is 40%, and the third threshold is set to 0.5V.

When none of the four relays 81a-81d has an ON failure, as each of the four relays 81a-81d is turned ON one by one, the summed value output from the integration circuit 84 becomes 0.25V each time. In contrast, when one of the four relays 81a-81d has an ON failure, when relays other than the relay with the ON failure are turned ON, the summed value output from the integration circuit 84 becomes 0.5V, and when the relay with the ON failure is turned ON, the summed value output from the integration circuit 84 becomes 0.25V.

If the second controller 86 determines that the summed value output from the integration circuit 84 is equal to or greater than the third threshold (Yes in step S34), it determines that the relay selected as the diagnosis target among the four relays 81a-81d is normal in terms of ON failure (step S35). In contrast, if the second controller 86 determines that the summed value output from the integration circuit 84 is less than the third threshold (No in step S34), it determines that the relay selected as the diagnosis target among the four relays 81a-81d has an ON failure (step S37). In this way, the second controller 86 can identify which relay among the plurality of relays has an ON failure.

While it is possible to verify whether an output signal is correctly output from the circuit, it is difficult to verify whether the circuit is operating normally, that is, to verify the ON/OFF operation of relays. As mentioned earlier, since relay circuits may experience ON/OFF failures, it is more important to verify the actual output state than the correctness of the control signal given to the relay circuit. Especially for relay circuits functioning as safety devices mounted on multicopters, operation verification before flight is required. When using a general-purpose ECU (Electronic Control Unit), as the number of relays subject to ON/OFF control increases, it becomes difficult to monitor the state of output signals output from all relays due to constraints on the number of ports or optimization of connectors. Similar challenges remain even when using a custom (dedicated) ECU.

The termination system according to an example embodiment of the present disclosure, and the multicopter including such a termination system, enable fault diagnosis of the relay circuit with a relatively simple circuit configuration. It is possible to reduce not only the number of MCU ports but also the number of AD converter circuits. Even if the number of rotors, that is, the number of relays increases, it is possible to appropriately perform fault diagnosis of the relay circuit using, for example, a general-purpose ECU without increasing the number of input circuits. This is also advantageous in terms of cost.

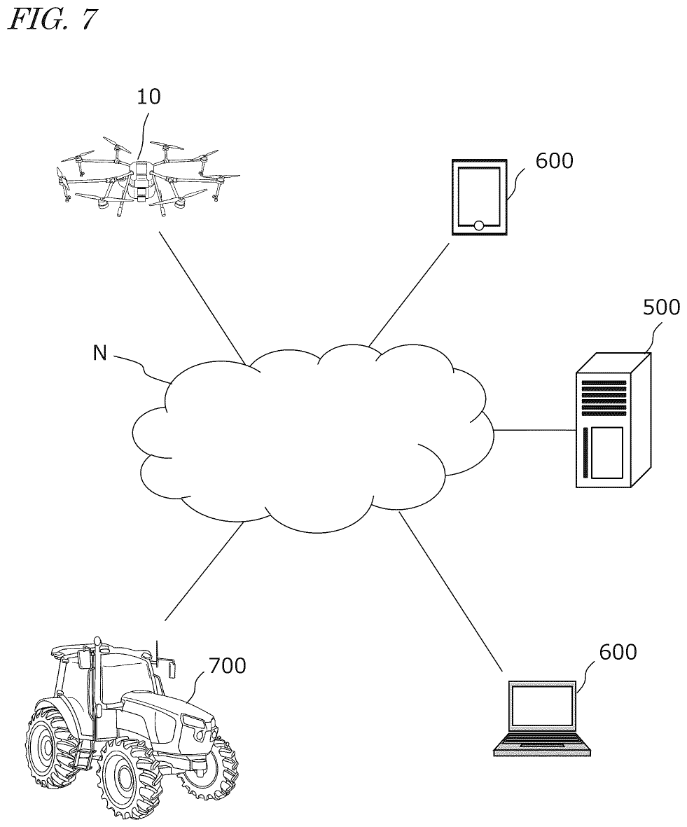

The controller 4a, as mentioned earlier, may be configured or programmed to include, for example, a flight controller such as a flight controller and a higher-level computer (companion computer). The companion computer may execute each process required for fault diagnosis and provide flight stop commands to the relay circuit 80 based on the results of these processes. Additionally, some or all of the functions of electronic equipment such as the controller 4a and the diagnostic device 82 mounted on the multicopter 10 may be realized by one or more servers (computers) 500 or terminal devices (including portable and fixed types) 600 connected to the communication device 4c of the multicopter 10 via a communication network N, as shown in FIG. 7. Agricultural machines 700 such as tractors may be connected to such a communication network N, and communication may be performed between the multicopter 10 and the agricultural machine 700. Through the communication network N, some of the data used for processing by the controller 4a or the diagnostic device 82, and control signals for the multicopter 10, may be provided to the multicopter 10 from the agricultural machine 700.

Systems providing various functions in the example embodiments can also be attached afterward to multicopters that do not have those functions. Such systems can be manufactured and sold independently of multicopters. Computer programs used for such systems can also be manufactured and sold independently of multicopters. Computer programs can be provided stored on a non-transitory computer-readable storage media, for example. Computer programs can also be provided through downloads via telecommunications lines (such as the Internet).

Unmanned aerial vehicles according to example embodiments of the present disclosure may be widely utilized not only for aerial photography, surveying, logistics, and agricultural spraying applications but also for ground work related to agriculture, transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An unmanned aerial vehicle comprising a plurality of rotors, the unmanned aerial vehicle comprising:
a plurality of electric motors each configured to rotate a respective one of the plurality of rotors;
a plurality of motor drive circuits each configured to drive a respective one of the plurality of electric motors; and
a controller configured or programmed to control operation of the plurality of motor drive circuits; wherein
the controller is configured or programmed to change the operation of the plurality of motor drive circuits from a flight state of the unmanned aerial vehicle to a state where flight is not possible in response to a stop signal.

2. The unmanned aerial vehicle according to claim 1, further comprising a relay circuit electrically connected between the plurality of motor drive circuits and the controller; wherein
the relay circuit is configured to interrupt a control signal transmitted from the controller to control rotation speed of the rotors in response to the stop signal to stop the operation of the plurality of motor drive circuits.

3. The unmanned aerial vehicle according to claim 2, further comprising a diagnostic device configured to execute fault diagnosis of the relay circuit based on an output from the relay circuit.

4. The unmanned aerial vehicle according to claim 3, wherein the diagnostic device is configured or programmed to execute fault diagnosis of the relay circuit before takeoff of the unmanned aerial vehicle.

5. The unmanned aerial vehicle according to claim 4, wherein the relay circuit includes a plurality of relays to interrupt the control signal in response to the stop signal.

6. The unmanned aerial vehicle according to claim 5, wherein the diagnostic device is configured or programmed to execute diagnosis of ON/OFF failures of the plurality of relays.

7. The unmanned aerial vehicle according to claim 6, further comprising a warning device configured to issue a warning about an ON/OFF failure of at least one of the plurality of relays; wherein
the diagnostic device is configured or programmed to:
execute the diagnosis of ON/OFF failures of the plurality of relays when the unmanned aerial vehicle is powered on; and
cause the warning device to issue the warning when an ON/OFF failure of at least one of the plurality of relays is detected.

8. The unmanned aerial vehicle according to claim 6, wherein
the controller is a first controller; and
the diagnostic device includes:
a plurality of averaging circuits each connected to a motor drive circuit side of a respective one of the plurality of relays;
an integration circuit configured to output a summed value by summing output values from each of the plurality of averaging circuits; and
a second controller configured or programmed to detect an ON/OFF failure of at least one of the plurality of relays based on the summed value output from the integration circuit.

9. The unmanned aerial vehicle according to claim 8, wherein:
the control signal is a Pules Width Modulation (PWM) signal; and
each of the plurality of averaging circuits is configured to output an analog voltage corresponding to a duty ratio of the PWM signal.

10. The unmanned aerial vehicle according to claim 8, wherein the second controller is configured or programmed to:
control ON/OFF operation of each of the plurality of relays; and
determine that at least one of the plurality of relays has an ON failure when the summed value output from the integration circuit is equal to or greater than a threshold, in a case where the second controller is configured or programmed to control the plurality of relays so that all of the plurality of relays are in the OFF state when the control signal is input from the first controller to the relay circuit.

11. The unmanned aerial vehicle according to claim 8, wherein the second controller is configured or programmed to:
control ON/OFF operation of each of the plurality of relays; and
determine that one relay of the plurality of relays experienced an ON failure or an OFF failure when the summed value output from the integration circuit is less than a threshold, in a case where the second controller is configured or programmed to control the plurality of relays so that after all of the plurality of relays are turned OFF when the control signal is input from the first controller to the relay circuit, the one relay of the plurality of relays is in the ON state.

12. The unmanned aerial vehicle according to claim 11, wherein the threshold used to determine an ON failure of the one relay of the plurality of relays is larger than the threshold used to determine an OFF failure of the one relay of the plurality of relays.

13. A termination system for terminating operation of a plurality of motor drive circuits and usable in an unmanned aerial vehicle including a plurality of rotors, a plurality of electric motors each configured to rotate a respective one of the plurality of rotors, the plurality of motor drive circuits each configured to drive a respective one of the plurality of electric motors, and a controller configured or programmed to control operation of each of the plurality of motor drive circuits, the termination system being configured or programmed to output a stop signal to the controller to change the operation of the plurality of motor drive circuits from a flight state of the unmanned aerial vehicle to a state where flight is not possible.

14. The termination system according to claim 13, further comprising an operation terminal to output the stop signal to the controller when the unmanned aerial vehicle is positioned above a field.

15. The termination system according to claim 13, further comprising a relay circuit electrically connected between the plurality of motor drive circuits and the controller, wherein the relay circuit is configured to interrupt a control signal transmitted from the controller to control rotation speed of the rotors in response to the stop signal to stop the operation of the plurality of motor drive circuits.

16. The termination system according to claim 15, further comprising a diagnostic device configured or programmed to execute fault diagnosis of the relay circuit based on an output from the relay circuit.
